(19) United States
(12) Patent Application Publication
(10) Pub. No.: US 2007/0239436 A1
(43) Pub. Date: Oct. 11, 2007

(54) Methods and instructions for outputting data comprising a data dictionary

(76) Inventor: Robert S. Kolman, Longmont, CO (US)

Correspondence Address: VERIGY, 4700 INNOVATION WAY, BLDG D1, FORT COLLINS, CO, 80528, US

(21) Appl. No.: 11/400,573

(22) Filed: Apr. 6, 2006

(51) Int. Cl. G06F 17/21

(52) U.S. Cl. 704/10

(57) ABSTRACT

In one embodiment, a method has steps for 1) determining a number of data types and associated data structure definitions, the data types being utilized as potential output by a machine running a program; 2) creating a data dictionary with listings, the listings comprising the data types and the associated data structure definitions; and 3) outputting the data dictionary for the machine running the program.

### BACKGROUND

Many computing environments segment data generation resources from data processing resource in order to maximize the performance of each. One process or processor may be dedicated to data generation and another process or processor dedicated to data processing. A tester is a specialized data generation machine used to perform tests on devices under test (DUTs) and generate test data. Other machines are then dedicated to execute programs for the processing of the generated data, including presentation, analysis, or storage of the generated data.

In order to maximize tester performance, the test data generated may be optimized so as to minimize the use of processing and bandwidth resources. In one example, an enumeration may be used to describe the type of data that follows, for instance, “1, 4.0” and “2, 0.03” where the “1” identifies one type of record and the “2” identifies another type, such as voltage and amperage. The data that follow are the values (e.g., 4.0 volts, 0.03 amperes) associated with each respective record type. It is important that data generators and data consumers utilize the same format to ensure proper processing of the data. Updating the format becomes a burdensome and error prone task to ensure all devices utilize the same format. The task is even more burdensome if different data formats are utilized within the same computing environment.

### SUMMARY OF THE INVENTION

In one embodiment, a method comprises steps for 1) determining a number of data types and associated data structure definitions, the data types being utilized as potential output by a machine running a program; 2) creating a data dictionary with listings, the listings comprising the data types and the associated data structure definitions; and 3) outputting the data dictionary for the machine running the program.

In a second embodiment, one or more machine-readable mediums have stored thereon sequences of instructions, which, when executed by a machine, cause the machine to perform the action of outputting an accessed data dictionary, the data dictionary comprising data types and associated data structure definitions utilized as potential output by the program.

In a third embodiment, one or more machine-readable mediums have stored thereon sequences of instructions, which, when executed by a machine, cause the machine to perform the actions of 1) determining a number of data types and associated data structure definitions, the data types being utilized as potential output by a machine running a program; 2) creating a data dictionary with listings, the listings comprising the data types and the associated data structure definitions; and 3) outputting the data dictionary for the machine running the program.

Other embodiments are also disclosed.

### BRIEF DESCRIPTION OF THE DRAWINGS

Illustrative embodiments of the invention are illustrated in the drawings, in which:

FIG. 1 illustrates an exemplary method for outputting a data dictionary;

FIG. 2 illustrates a block diagram for a processing system for executing the method of FIG. 1 to output a data dictionary;

FIG. 3 illustrates an exemplary first data dictionary output by a processor, such as in FIG. 2;

FIG. 4 illustrates an exemplary first segment of output from a processor, such as in FIG. 2, utilizing a data dictionary, such as in of FIG. 3;

FIG. 5 illustrates an exemplary second data dictionary output by a processor, such as in FIG. 2;

FIG. 6 illustrates an exemplary second segment of output from a processor, such as in FIG. 2 utilizing the data dictionary of FIG. 5; and

FIG. 7 illustrates an exemplary system with a machine executing the method of FIG. 1.

### DETAILED DESCRIPTION OF THE INVENTION

As a preliminary matter, it is noted that, in the following description, like reference numbers appearing in different drawing figures refer to like elements/features. Often, therefore, like elements/features that appear in different drawing figures will not be described in detail with respect to each of the drawing figures.

Machines, such as testers, produce an output in accord with the execution of a program. The output of a tester may comprise various types of test data (e.g., test identifiers, time stamps, test results, et cetera). The test results are the observations of one or more devices under test (DUTs) in response to a test. The format of the tester's output may vary from one tester to another or within a tester over time. This variation may be due to new technology, testing methods, output standards, or other event.

The output of a tester is commonly optimized to reduce the use of bandwidth and data reporting resources. As a result, symbols are often used. One such symbol is a data type. A data type is a link to a structure definition describing the form of an associated data value. In its simplest form, a data type is an indicator for a standard data type (e.g., long integer, short integer, float, double, string, et cetera) and, also in its simplest form, is associated with a single data value. For example “3, 200” wherein “3” is a data type associated with the standard data type “short” (e.g., unsigned integer of two bytes) and the next number (“200”) is the associated value. In more complex forms, the data type is associated with a structure containing combinations of values, standard data types, and/or data types. For example, a data type of “99” may be associated with a “date” structure. Following a data type “99” indicator are, for example, a short (day), a string (month), an int (year), and a “time struct”. The “time struct” may be a nested structure comprised of its own data types and values for hours, minutes, seconds, and so on. In practice, one or more values may be blank (e.g., zero or null).

Data consumers, such as those that format, present, store, organize, and analyze the output of the tester, must understand the format of the test data produced by a tester. If a data consumer only received test data in one format then synchronizing the data format between the tester and data consumer would be a one-time event. However, more complex scenarios are often implemented, such as when a data consumer receives output from one tester (e.g., wherein the data type “3” refers to an “int” form of a voltage value), then receive output from a second tester (e.g., wherein the data type “3” refers to a long integer form of an amperage value), and then receive output from a third tester (e.g., wherein the data type “3” refers to a string value of a date value). Keeping the tester's output format synchronized with the data consumer's input format is burdensome and error prone. A single tester may output test data in different formats to further contribute to the burden and error potential of processing multiple formats.

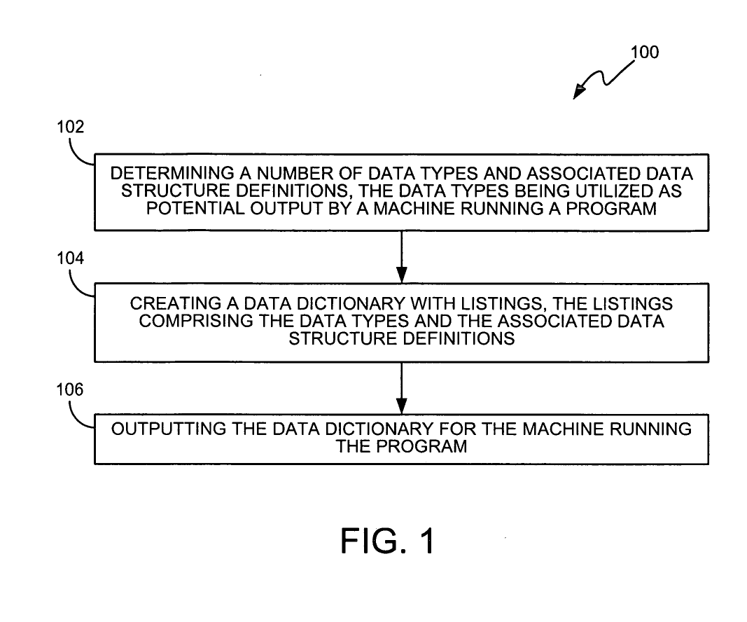

FIG. 1 illustrates exemplary method 100 for outputting a data dictionary. Method 100 includes steps 102, 104, and 106 for 1) determining a number of data types and associated data structure definitions, the data types being utilized as potential output by a machine running a program; 2) creating a data dictionary with listings, the listings comprising the data types and the associated data structure definitions; and 3) outputting the data dictionary for the machine running the program.

In another embodiment, the machine of method 100 is a tester operable to perform tests on a number of devices under test and the program is instructions that cause the machine to perform the tests.

In another embodiment, the step for outputting the data dictionary comprises outputting the data dictionary as a first output of the machine running the program. In another embodiment, the step for outputting the data dictionary comprises outputting the data dictionary as a header to a data output of the machine running the program. In yet another embodiment, the step for outputting the data dictionary comprises writing the data dictionary to a data store. In a further embodiment, the step of writing the data dictionary to a data store includes retrieving the data dictionary form the data store and adding additional listings to the data dictionary.

In another embodiment, the step for determining the number of data types and associated data structure definitions comprises, executing code during compilation of the program's source code to parse the source code to 1) determine ones of the number of data types and associated data structure definitions and 2) provide access to the number of data types and associated data structure definitions available for creating the data dictionary. In a further embodiment, the data dictionary is stored within a file containing the compiled code of the program.

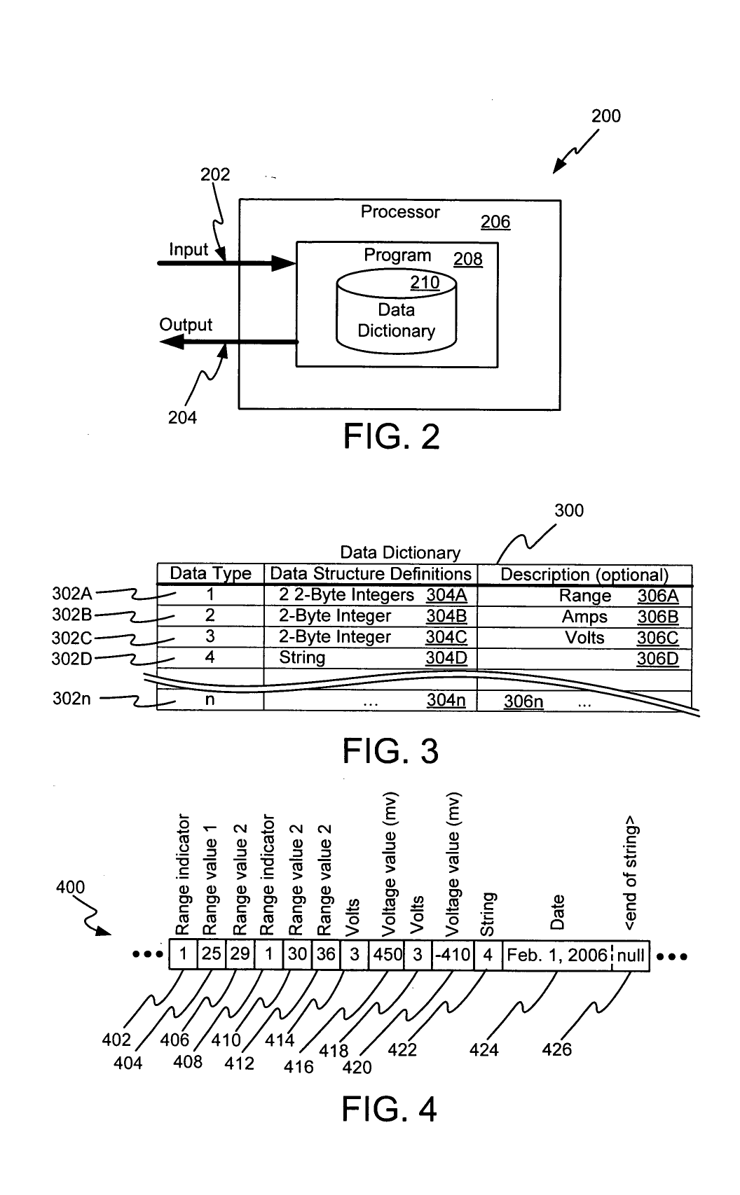

FIG. 2 illustrates a block diagram for processing system 200 for executing the method of FIG. 1 to output a data dictionary. Processor 206 communicates with other processes and devices with input 202 and output 204. Processor 206 executes program 208 with data dictionary 210. In one embodiment, data dictionary 210 resides in, and is retrieved from, a portion of program 208. That is, data dictionary 210 is stored as part of the static instruction code program 208. The actual location of program 208 may include main memory, processor memory, cache, paging memory, or other location for instructions as determined by processor 206 and/or the operating system of processor 206 for executing program 208. In another embodiment, data dictionary 210 is derived from program 208, such as by another program operable to analyze the source code of program 208. In one example, program 208 comprises a plurality of complied files and/or run-time linked files (e.g., object files, dynamic linked libraries, executable files, et cetera). One or more files then contribute listings to an aggregated data dictionary 210. In yet another embodiment, data dictionary 210 originates, and is retrieved from, a location external to program 208 such that data dictionary 210 is stored in dynamic memory (e.g., as a data value) of program 208.

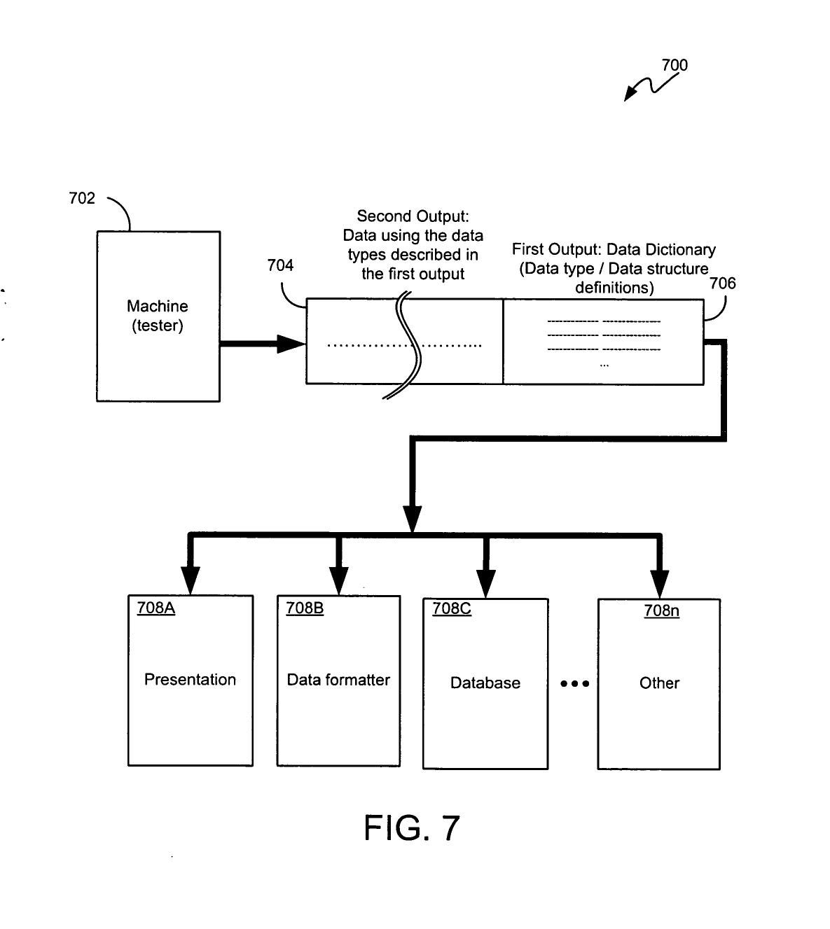

FIG. 3 illustrates exemplary first data dictionary 300 output by a processor, such as in FIG. 2. Data dictionary 300 is one exemplary form of data dictionary 210 from program 208. Data dictionary 300 is illustrated with headings for clarity. Headings may be implemented as a matter of design choice. Data dictionary 300 is also illustrated with numeric data types 302, data structure definitions 304, and optional descriptions 306. Data type 302 may be any datum operable to serve as a key to an associated data structure definition 304. Similarly, data structure definitions 304 may be in any form readable by the data consumers (see, FIG. 7) of data dictionary 300 for the associating of data types in a stream of data (see, FIGS. 4 and 6) with data types utilized by the data consumers. Data dictionary 300 includes ones of data type 302A-302n associated with corresponding ones of data structure definitions 304A-304n and optionally, descriptions 306A-306n.

Optional descriptions 306 provide a secondary means to identify and/or document the values in data dictionary 300. As one example, the value “3” may be an integer associated with description 306C (“Volts”). Descriptions 306 may be English text, as illustrated, or in other embodiments, other human or machine-readable form.

FIG. 4 illustrates an exemplary first segment 400 of output from a processor, such as in FIG. 2, utilizing a data dictionary, such as data dictionary 300 of FIG. 3. Program 208 outputs data of which first segment 400 represents a portion. First segment 400 includes records comprising 1) data types 402, 408, 414, 418, 422 and 2) one or more associated data values 404, 406; 410, 412; 416; 420; 424. String 424 is variable length and terminated by null value 426. In one embodiment, null value 426 is distinct from date element 424. In another embodiment, null value 426 is part of the data within data element 424. The actual structure of first segment 400 is variable. For example, one data type may be associated with a variable or fixed number of data values for that one data type. Other data types may be associated with a structure comprising different data types and their associated data values.

First segment 400 includes elements 402-426, element 402 has a value of “1”. The value “1” is associated with data type 302A, which is then associated with data structure definition 304A (“2 2-byte integers”) and optional description 306A (“Range”). Following element 402, now determined to be a “range” data type, are two range elements 404, 406 providing the values for range 402. Range element 408 is similarly followed by range elements 410, 412. Element 414 has the value of “3”. The value “3” is associated with data type 302C, which in turn is associated with data structure definition 304C (“2-byte integer”) and optional description 306C (“Volts”). A single voltage value 416 follows element 414 (“450 mv”). Similarly, voltage element 418 also has a value of “3” indicating an association with data type 302C, which is then associated with data structure definition 304C (“2-byte integer”) and optional data type 306C (“Volts”), and followed by voltage element 420 (“−410 mv”). Element 422 has a value of “4” indicating data structure definition 304D (“String”). Element 424 contains the string value and, if variable length, includes a string terminator, such as null-value 426.

FIGS. 3 and 4 represent the output of a processor, such as processor 206 running program 208. See, FIG. 2. Data dictionary 300 is output prior to first segment 400. Data consumers reading the output of processor 206 are then able to correctly translate the data types used in first segment 400 by receiving data dictionary 300 as part of the output. Data consumers reading the output can change formats simply by receiving a new data dictionary prior to processing the test data utilizing the new format.

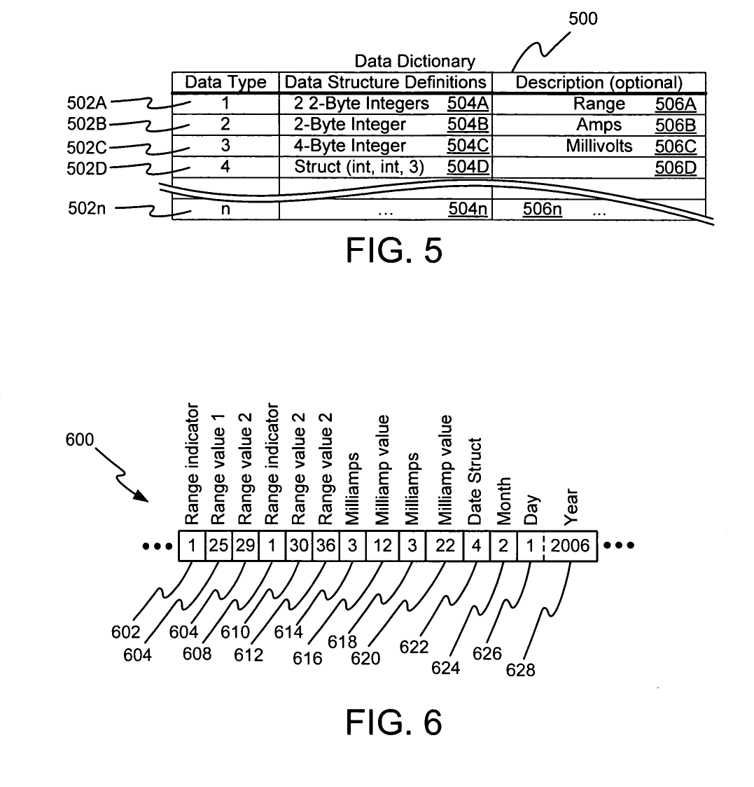

FIG. 5 illustrates exemplary second data dictionary 500 output from a processor, such as processor 206 in FIG. 2. In one embodiment, second data dictionary 500 is produced from modification to program 208 executed on processor 206. In another embodiment, second data dictionary output 500 is produced from a program other than program 208 which may be executed on processor 206 or another processor. Data dictionary 500 is illustrated with headings for clarity. Headings may be included as a matter of design choice. Data dictionary 500 is also represented as English alpha-numeric text and, as previously described, can be represented in other forms. See, FIG. 3 supra.

Like data dictionary 300 in FIG. 3, data type 502A (“1”) is associated with data structure definition 504A (“2 2-byte integers”) and optional description 506A (“Range”) and data type 502B (“2”) is associated with data structure definition 504B (“2-byte integer”) and optional description 506B (“Amps”). However, data types 502C (“3”) is now associated with data structure definition 504C (“4-byte integer”) and optional description 506C (“Millivolts”) and data type 502D (“4”) is now associated with data structure definition 504D (“Struct(int, int, 3)”). Data structure definitions 504 may include a plurality of elements and nested other data structure definitions 504. For example, data structure definition 504D is a structure with three elements: a first integer, a second integer, and a data type of “3” which is defined by data type 502C, which is then associated with data structure definition 504D (“4-byte integer”).

FIG. 6 illustrates an exemplary second segment 600 of output from a processor, such as processor 206 of FIG. 2 utilizing a data dictionary, such as data dictionary 500 of FIG. 5. Second segment 600 contain data type values “1, 1, 3, 4” (602, 608, 614, 618, 622), respectively. With benefit of first receiving data dictionary 500, a data consumer processing output 204, would be able to correctly parse second segment 600 and, for example, correctly determine element 614 (“3”) is milliamps rather than voltage, as it was in FIG. 4, as well as determining element 622 (“4”) indicates two “int's” and one of data type 502C (“3”).

FIG. 7 illustrates an exemplary system with machine 702 executing the method of FIG. 1. Machine 702, such as a tester, produces an output 704, 706. The output is segmented into first output 706 and second output 704. First output 706 comprises data types and associated data structure definitions. Second output 704 includes test data formatted in accord with the data types described in the data dictionary of first output 706. Data consumers 708 receive and format, store, present, organize, and/or analyze the output of machine 702 and optionally of other machines. Data consumers 708 utilize data dictionary 706 to translate data types found in second output 704 into structure definitions to facilitate reading and processing of the data values associated with the data types.

What is claimed is:

1. A method, comprising:
determining a number of data types and associated data structure definitions, the data types being utilized as potential output by a machine running a program;
creating a data dictionary with listings, the listings comprising the data types and the associated data structure definitions; and
outputting the data dictionary for the machine running the program.

2. The method of claim 1, wherein:
the machine is a tester operable to perform tests on a number of devices under test; and
the program is instructions that cause the machine to perform the tests.

3. The method of claim 1, wherein outputting the data dictionary comprises outputting the data dictionary as a first output of the machine running the program.

4. The method of claim 1, wherein outputting the data dictionary comprises outputting the data dictionary as a header to a data output of the machine running the program.

5. The method of claim 1, wherein outputting the data dictionary comprises writing the data dictionary to a data store.

6. The method of claim 5, further comprising, retrieving the data dictionary from the data store and adding additional listings to the data dictionary wrote to the data store.

7. The method of claim 1, wherein determining the number of data types and associated data structure definitions comprises, executing code during compilation of the program's source code to parse the source code to 1) determine ones of the number of data types and associated data structure definitions and 2) provide access to the number of data types and associated data structure definitions available for creating the data dictionary.

8. The method of claim 7, further comprising, storing the data dictionary within a file containing the complied code of the program.

9. One or more machine-readable mediums having stored thereon sequences of instructions, which, when executed by a machine, cause the machine to perform the action of outputting an accessed data dictionary, the data dictionary comprising data types and associated data structure definitions utilized as potential output by the program.

10. The machine-readable mediums of claim 9, further comprising instructions, which when executed by the machine, cause the machine to perform the action of accessing the data dictionary stored within the program.

11. The machine-readable mediums of claim 9, further comprising instructions, which when executed by the machine, cause the machine to perform the action of accessing the data dictionary stored in a data store.

12. The machine-readable mediums of claim 9, further comprising instructions, which when executed by the machine, cause the machine to perform the actions of:
controlling the program with a tester operable to perform tests on a number of devices under test; and
executing the program to perform the tests.

13. The machine-readable mediums of claim 9, further comprising instructions, which when executed by the machine, cause the machine to perform the action of outputting the data dictionary as a first output of the program.

14. The machine-readable mediums of claim 9, further comprising instructions, which when executed by the machine, cause the machine to perform the action of outputting the data dictionary as a header to a data output of the program.

15. The machine-readable mediums of claim 9, further comprising instructions, which when executed by the machine, cause the machine to perform the actions:
analyzing the program to determine the number of data types and the associated data structure definitions of the program;
building the data dictionary; and
storing the data dictionary.

16. The machine-readable mediums of claim 15, wherein the instruction for analyzing the program further comprise instructions for analyzing the source code of the program

17. The machine-readable mediums of claim 15, wherein the instructions for storing the data dictionary further comprise instructions to store the data dictionary in a portion of the compiled machine code of the program.

18. One or more machine-readable mediums having stored thereon sequences of instructions, which, when executed by a machine, cause the machine to perform the actions:
determining a number of data types and associated data structure definitions, the data types being utilized as potential output by a machine running a program;
creating a data dictionary with listings, the listings comprising the data types and the associated data structure definitions; and
outputting the data dictionary for the machine running the program.

19. The machine-readable mediums of claim 18, further comprising instructions, which when executed by the machine, cause the machine to perform the actions of outputting the data dictionary as a first output of the machine running the program.

20. The machine-readable mediums of claim 18, further comprising instructions, which when executed by the machine, cause the machine to perform the actions of outputting the data dictionary as a header of the data output from the machine running the program.

21. The machine-readable mediums of claim 18, further comprising instructions, which when executed by the machine, cause the machine to perform the actions of writing the data dictionary to a data store.
